(19) United States
(12) Patent Application Publication
(10) Pub. No.: US 2025/0321797 A1
(43) Pub. Date: Oct. 16, 2025

(54) SYSTEMS AND METHODS FOR OBJECT PAIRINGS USING ARTIFICIAL INTELLIGENCE MODELS

(71) Applicant: Palantir Technologies Inc., Denver, CO (US)

(72) Inventors: Lauren Shearer, Harrisonburg, VA (US); Anand Gupta, Snowmass Village, CO (US); Cassandra Wang, Breckenridge, CO (US); Tess Druckenmiller, Brooklyn, NY (US); Dan Cervelli, Wanaka (NZ); Vineel Kodikanti, Vienna, VA (US)

(21) Appl. No.: 18/752,473

(22) Filed: Jun. 24, 2024

Related U.S. Application Data
(60) Provisional application No. 63/634,758, filed on Apr. 16, 2024.

(51) Int. Cl. G06F 9/50

(52) U.S. Cl. CPC G06F 9/5027

(57) ABSTRACT

In some examples, systems and methods for object pairings are provided. For example, a method includes: receiving an input associated with at least one of the one or more first values of one or more weights, the one or more weights corresponding to one or more model parameters associated with a task; determining one or more second values of the one or more weights, at least one second value of the one or more second values of the one or more weights being determined based at least in part on the input; modifying the machine-learning model based on the one or more second values of the one or more weights; determining a plurality of object pairings for the task by applying the modified machine-learning model to data associated with the task, each object pairing of the plurality of object pairings including an asset object and the target object.

This application claims priority U.S. Provisional Application No. 63/634,758, filed Apr. 16, 2024, which is incorporated in its entirety by reference herein for all purposes.

### FIELD

Certain embodiments of the present disclosure relate to object pairings. More particularly, some embodiments of the present disclosure relate to object pairings (e.g., assets and targets pairings) using artificial intelligence (AI) models.

### BACKGROUND

Many tasks are performed on one or more targets and by consuming certain assets. In some examples, object pairings are used to select one or more assets for accomplishing tasks. In certain examples, object pairings often evaluate a large number of assets and a large number of targets.

Hence, it is desirable to improve techniques for object pairings.

### SUMMARY

Certain embodiments of the present disclosure relate to object pairings. More particularly, some embodiments of the present disclosure relate to object pairings (e.g., assets and targets pairings) using artificial intelligence (AI) models.

At least some embodiments are directed to a method for object pairings. In certain embodiments, the method includes: presenting, on a display, one or more first values of one or more weights in a machine-learning model, the one or more weights corresponding to one or more model parameters associated with a task, the task including one or more asset objects, a target object, and one or more task contexts; receiving an input associated with at least one of the one or more first values of the one or more weights; determining one or more second values of the one or more weights, at least one second value of the one or more second values of the one or more weights being determined based at least in part on the input; modifying the machine-learning model based on the one or more second values of the one or more weights; determining a plurality of object pairings for the target object by applying the modified machine-learning model to data associated with the task, each object pairing of the plurality of object pairings including an asset object and the target object; and generating a ranking associated with the plurality of object pairings for the task; wherein the method is performed by one or more processors.

At least some embodiments are directed to a method for object pairings. In certain embodiments, the method includes: receiving first task data associated with a task at a first time, the first task data including data associated with one or more asset objects, data associated with one or more target objects, and data associated with the task, at least a part of the task data including live data associated with at least one of the one or more asset objects; generating a plurality of first object pairings and a plurality of first ranking scores by applying a machine-learning model to the first task data, the machine-learning model including one or more model parameters associated with a task, the task including one or more asset objects, a target object, and one or more task contexts; presenting, on a display, the plurality of first object pairings and the plurality of first ranking scores; receiving second task data associated with the task at a second time, the second time being later than the first time, the live data at the second time being different from the live data at the first time; generating a plurality of second object pairings and a plurality of second ranking scores by applying the machine-learning model to the second task data, at least one of the plurality of second object pairings being different from at least one of the plurality of first object pairings or at least one of the plurality of second ranking scores being different from at least one of the plurality of first ranking scores for a same object pairing; presenting, on the display, the plurality of second object pairings and the plurality of second ranking scores; wherein the method is performed by one or more processors.

At least some embodiments are directed to a system for object pairing. In some embodiments, the system includes: one or more memories comprising instructions stored thereon; and one or more processors configured to execute the instructions and perform operations comprising: presenting, on a display, one or more first values of one or more weights in a machine-learning model, the one or more weights corresponding to one or more model parameters associated with a task, the task including one or more asset objects, a target object, and one or more task contexts; receiving an input associated with at least one of the one or more first values of the one or more weights; determining one or more second values of the one or more weights, at least one second value of the one or more second values of the one or more weights being determined based at least in part on the input; modifying the machine-learning model based on the one or more second values of the one or more weights; determining a plurality of object pairings for the task using the modified machine-learning model applied to data associated with the task, each object pairing of the plurality of object pairings including an asset object and the target object; and generating a ranking associated with the plurality of object pairings for the task.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is a simplified diagram showing a method for managing AI models for object pairings according to certain embodiments of the present disclosure.

FIG. 2 is a simplified diagram showing a method for object pairings using AI models according to certain embodiments of the present disclosure.

FIG. 3 is an illustrative tasking (e.g., object pairings) operating environment according to certain embodiments of the present disclosure.

FIG. 4 illustrates an example user interface for presenting one or more selected model parameters and corresponding weights and values, according to certain embodiments of the present disclosure.

FIG. 5 is an illustrative user interface according to certain embodiments of the present disclosure.

FIG. 6 is a simplified diagram showing a computing system for implementing a system for object pairings in accordance with at least one example set forth in the disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any number within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

Conventional systems and methods are often manually assigning assets to targets for tasks, which is very time-consuming. Additionally, conventional systems and methods often do not use context information for tasks, such that the pairing may not have correct results.

Various embodiments of the present disclosure can achieve benefits and/or improvements by using an object-pairing system (e.g., software module), or referred to as a tasking system, for example, providing object pairings (e.g., a pairing of an asset object and a target object, etc.) in scale with improved efficiency and accuracy. In certain embodiments, the object-pairing system uses one or more artificial intelligence (AI) models to perform object pairings to achieve desirable pairing outcomes. In some embodiments, the object-pairing system inputs context information associated with tasks, one or more asset objects, one or more target objects to the one or more AI models to recommend object pairings, such that the object pairing efficiency and accuracy are improved. In certain embodiments, the object-pairing system generates and/or selects parameters of the AI models and allows users and/or other systems to modify weight values associated with the selected parameters, such that the AI models are improved. In some embodiments, the object-pairing system continuously trains the AI models using object pairings selected by users and/or other systems, such that the AI models are improved.

According to some embodiments, systems and methods of the present disclosure provide object pairings, for example, pairings of one or more asset objects and one or more target objects. In certain embodiments, an object-pairing system, also referred to as a tasking system, can provide object pairings for one or more tasks. In some embodiments, the object-pairing system can use one or more computational models (e.g., machine learning models, artificial neural networks, etc.) to generate object pairings and optional rankings of the object pairings. In some embodiments, a target object refers to a physical object (e.g., a vehicle, an airplane, a building, etc.) for a task to perform. In certain embodiments, a target object can be a moving object or a static object. In some embodiments, an asset object refers to a physical object (e.g., a vehicle, an airplane, etc.) to be used by the task. For example, a task is to supply fuel to a target airplane (e.g., a target object) via a fuel airplane (e.g., an asset object). As an example, a task is to send an unmanned aerial vehicle (UAV) (e.g., an asset object) to a disaster site (e.g., a target object).

According to some embodiments, an object-pairing system can complete object pairings and/or help users complete object pairings. In certain embodiments, the object-pairing system is configured to allow users to assign assets to engage targets for tasks and/or aid in tasking assets to engage targets. In some embodiments, an object-pairing system also provides an operating visualization, allowing users to develop an understanding of the contextual information of the target objects, for example, environment (e.g., terrain, weather, etc.), impacting factors, and/or the like.

According to certain embodiments, the object-pairing system enables users to create target engagement plans and/or taskings at scale. In some embodiments, the object-pairing system provides users with a three-dimensional (3D) visualization that shows live context data associated with targets and assets, for example, terrain, fuel ranges, weather, and/or other contextual information critical to deciding how to engage a target.

According to some embodiments, the object-pairing system is unique in that it combines live entity data from a plurality of data sources, for example, such as, static mission data, dynamic object data, and/or the like. In certain embodiments, these data sources are of different systems. In some embodiments, the object-pairing system provides users with both important live data, such as position, speed, heading, important mission data, and/or the like. In certain embodiments, the object-pairing system also brings in contextual data like asset data, spaces, terrain, weather, and other data that can affect the feasibility of an engagement plan tasking.

According to certain embodiments, the object-pairing system employs artificial intelligence (AI) models to generate recommendations, also referred to as an AI Tasking Recommender Engine, for example, to encode logic to augment and improve operator decision-making. In some embodiments, the AI tasking recommender engine automatically recommends asset objects and target object pairings based on a set of relevant criteria. In certain embodiments, the object-pairing system includes a user interface to allow users to manipulate the weights of the one or more AI model in order to customize the results.

According to some embodiments, tasking recommendations are provided for individual taskings but can also be used to generate a plurality of recommendations (e.g., bulk recommendations), accelerating the pace of the tasking process. In some embodiments, the object-pairing system can generate automated alerts which are to alert a user of a possible conflict impacting a tasking, for example, when an airplane is calculated to run out of mission time or fuel. In certain embodiments, these capabilities dramatically improve the velocity and quality of tasking decisions by automatically surfacing pairing suggestions (e.g., optimal pairing suggestions) and alerts to aid in the assessment of task feasibility.

According to certain embodiments, the object-pairing system allows users to create templates, which serve to encode tactical playbooks users would otherwise draw up on whiteboards and in presentations. In some embodiments, a template includes one or more object pairings for a type of target. In certain embodiments, a playbook includes a plurality of object pairings (e.g., assets and targets pairings, etc.) corresponding to a plurality of tasks to perform in sequence and/or in parallel. In some embodiments, these templates can be used at any moment and used to rapidly assemble complex packages for complex target engagements. In certain embodiments, not only does the use of templates greatly speed up the process of creating a complex package, but by encoding it in object-pairing system, over time, users are better able to evaluate and assess the success/failure of these playbooks.

According to some embodiments, the object-pairing system (e.g., the tasking system) enables users to create simulated tasks (e.g., simulated missions) and simulated assets. In certain embodiments, simulated tasks can be used as part of training and even large-scale testing to increase the complexity and improve the realism of training and exercise scenarios (e.g., disaster relief scenarios, etc.). In some embodiments, the object-pairing systems can create simulated tasks, for examples, based on user inputs. In contrast, existing simulation solutions currently involve many engineers manually creating and publishing false data over the course of hours and days.

According to certain embodiments, the object-pairing system can include one or more computing models (e.g., one or more artificial intelligence (AI) models), also referred to as pairing models, for generating and/or facilitating the generation of object pairings. In some embodiments, a model, also referred to as a computing model, includes a model to process data. A model includes, for example, an artificial intelligence (AI) model, a machine learning (ML) model, a deep learning (DL) model, an image processing model, an algorithm, a rule, other computing models, and/or a combination thereof. In some embodiments, the object-pairing system can use one or more artificial neural network (ANN) models. In certain embodiments, the object-pairing system can generate and/or select one or more model parameters (e.g., model features, features) based at least in part on a type of task. In some embodiments, the selected model parameters are a subset of parameters of an input layer of one of the one or more ANN models. For example, for a type of task (e.g., a disaster relief task) that is to be performed for one or more target objects that have one or more location characteristics, the selected model parameters include, for example, a location of a target object, a location of an asset object, a movement direction of the asset object, a speed of the asset object, a distance, and/or the like.

In some embodiments, the object-pairing system can use an AI model (e.g., a ML model, a language model, a large language model, a generative AI model), referred to as a parameter AI model, to generate and/or select one or more selected model parameters for the one or more pairing models. In certain examples, a parameter AI model can include training data (e.g., a part of training corpus) embedded in the model. In some embodiments, the parameter AI model includes a generative AI (artificial intelligence) model with training data embedded in the model. In certain embodiments, a generative AI model is a type of AI models that can be used to produce various type of content, such as text, images, videos, audio, 3D (three-dimensional) data, 3D models, and/or the like. In some embodiments, a language model or a large language model (LLM), which is a type of generative AI models, includes content and training data embedded in the model.

According to some embodiments, the parameter AI model (e.g., a language model, an LLM, etc.) can be trained using selected corpus (e.g., historical tasks, historical object pairings, historical model parameters, etc.) and the parameter AI model is configured to generate model parameters for one or more pairing model. In some embodiments, the parameter model includes a language model (“LM”) that may include an algorithm, rule, model, and/or other programmatic instructions that can predict the probability of a sequence of words or expressions (e.g., software code). In some embodiments, a language model may, given a starting text string (e.g., one or more words), predict the next word or expression in the sequence. In certain embodiments, a language model may calculate the probability of different word combinations and/or software code based on the patterns learned during training (based on a set of text data from books, articles, websites, audio files, software code, etc.). In some embodiments, a language model may generate many combinations of one or more next words and/or expressions that are coherent and contextually relevant. In certain embodiments, a language model can be an advanced artificial intelligence algorithm that has been trained to understand, generate, and manipulate language (e.g., computing language expressions). In some embodiments, a language model can be useful for natural language processing, including receiving natural language prompts and providing natural language responses based on the text on which the model is trained. In certain embodiments, a language model may include an n-gram, exponential, positional, neural network, and/or other type of model. In some embodiments, a language model can be used to generate software code.

In certain embodiments, the parameter model includes a large language model (LLM), which was trained on a larger data set and has a larger number of parameters (e.g., billions of parameters) compared to a regular language model. In certain embodiments, an LLM can understand more complex textual inputs and generate more coherent responses due to its extensive training. In certain embodiments, an LLM can use a transformer architecture that is a deep learning architecture using an attention mechanism (e.g., which inputs deserve more attention than others in certain cases). In some embodiments, a language model includes an autoregressive language model, such as a Generative Pretrained Transformer 3 (GPT-3) model, a GPT 3.5-turbo model, a Claude model, a command-xlang model, a bidirectional encoder representations from transformers (BERT) model, a pathways language model (PaLM) 2, and/or the like.

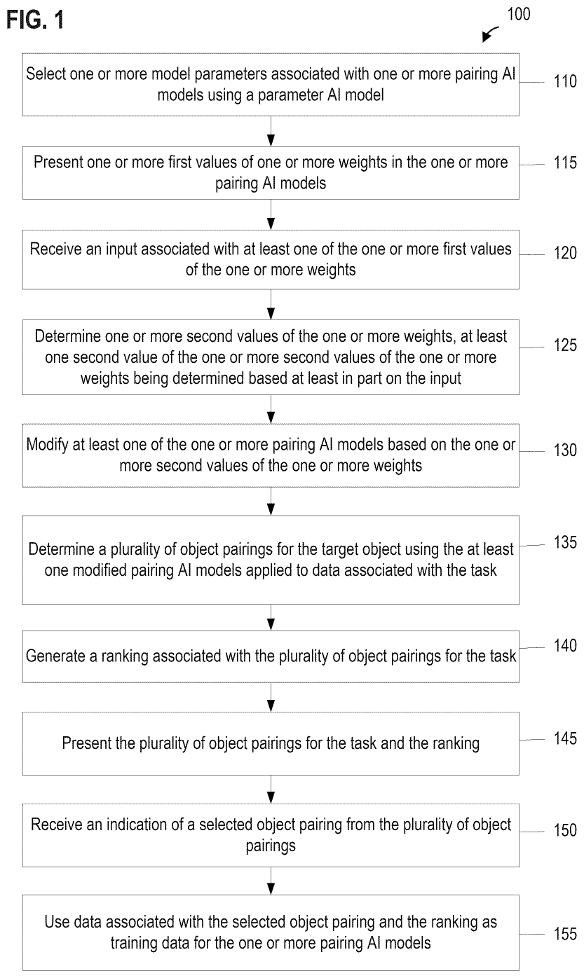

FIG. 1 is a simplified diagram showing a method 100 for managing AI models for object pairings according to certain embodiments of the present disclosure. This diagram is merely an example. One of ordinary skill in the art would recognize many variations, alternatives, and modifications. The method 100 for managing AI models for object pairings includes processes 110, 115, 120, 125, 130, 135, 140, 145, 150, and 155. Although the above has been shown using a selected group of processes for the method 100 for managing AI models for object pairings, there can be many alternatives, modifications, and variations. For example, some of the processes may be expanded and/or combined. Other processes may be inserted to those noted above. Depending upon the embodiment, the sequence of processes may be changed, and one or more processes may be replaced. Further details of these processes are found throughout the present disclosure.

In some embodiments, some or all processes (e.g., steps) of the method 100 are performed by a system (e.g., the computing system 600). In certain examples, some or all processes (e.g., steps) of the method 100 are performed by a computer and/or a processor directed by a code. For example, a computer includes a server computer and/or a client computer (e.g., a personal computer). In some examples, some or all processes (e.g., steps) of the method 100 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to certain embodiments, the system generates, updates, and/or uses one or more pairing AI models. In some embodiments, the one or more pairing AI models include a plurality of pairing AI models running in parallel and/or in sequence. In certain embodiments, the one or more pairing AI model include a first AI model and a second AI model, where output generated from the first pairing AI model is input to the second pairing AI model. In certain embodiments, the one or more pairing AI models include an artificial neural network (ANN) model and the one or more model parameters are for an input layer of the ANN model. In some embodiments, the ANN model is designed with a relatively small set of parameters such that the ANN model can generate output in real-time (e.g., less than 1 second, less than 0.2 second, less than 0.1 second, less than 3 seconds, etc.). In certain examples, the ANN model has an input layer having no more than 100 parameters. In some examples, the ANN model has an input layer having no more than 50 parameters. In certain embodiments, the one or more pairing AI models include one or more recommender models.

According to some embodiments, at process 110, the system selects one or more model parameters associated with one or more pairing AI models using a parameter AI model. In some embodiments, the parameter AI model includes a generative AI model to generate and/or select the one or more model parameters. In certain embodiments, the parameter AI model includes a generative AI model configured to generate the one or more pairing AI model. In some embodiments, the parameter AI model (e.g., a language model, an LLM, etc.) can be trained using corpus including historical tasks, historical object pairings, historical model parameters, and/or other data and the parameter AI model is designed to generate model parameters for the one or more pairing AI models. In certain embodiments, the parameter AI model (e.g., a language model, an LLM, etc.) can be trained using training dataset including historical tasks, historical object pairings, historical models, and/or other data and the parameter AI model is designed to generate the one or more pairing AI models.

In some embodiments, the model parameters are associated with one or more tasks and/or one or more types of tasks. In certain embodiments, the task includes one or more asset objects, one or more target objects, one or more task contexts, and/or the like. In some embodiments, the model parameters include one or more task parameters, one or more target object parameters, one or more asset object parameters, one or more task context parameters, and/or the like. In certain embodiments, the task parameters include a time, a sequence of times, geolocation, distance, and/or the like. For example, one or more task context parameters include one or more parameters associated with the task environment, such as weather, wind, terrain, and/or the like.

In some embodiments, the one or more object parameters include an object type, a location parameter, a geospatial parameter, a temporal parameter, a speed parameter, an orientation parameter, a movement parameter, a shape parameter, a spectrum parameter, an object image parameter, a fuel parameter, and/or the like. In certain embodiments, the one or more asset object parameters include one or more object parameters, an asset match parameter, an asset availability parameter, and/or the like. In some embodiments, the one or more target object parameters include one or more object parameters, one or more target object characteristics, and/or the like. In some embodiments, the one or more model parameters include one or more combined parameters, such as a time-to-target, a fuel-range, and/or the like. In certain embodiments, a combined parameter includes a parameter corresponding to data that needs to be computed. For example, the time-to-target is computed using geolocation, distance, heading, and speed. As an example, the asset-match is computed using task information and asset information.

According to some embodiments, at process 115, the system presents one or more model parameters and/or one or more first values of one or more weights in one or more pairing AI models, where the one or more weights correspond to one or more model parameters of the one or more pairing AI models, for example, associated with a task. In some embodiments, the one or more model parameters presented are selected parameters from the parameters of the one or more pairing AI models. In certain embodiments, the one or more model parameters are selected based on a task and/or a task type. In some embodiments, a task type refers to a type of task that is associated with a set of target object types and a set of asset object types. For example, a disaster relief task type is associated with target object types of buildings, areas, and/or the like, and asset object types of fire engines, firefighters, rescue persons, rescue robots, airplanes, UAVs, and/or the like.

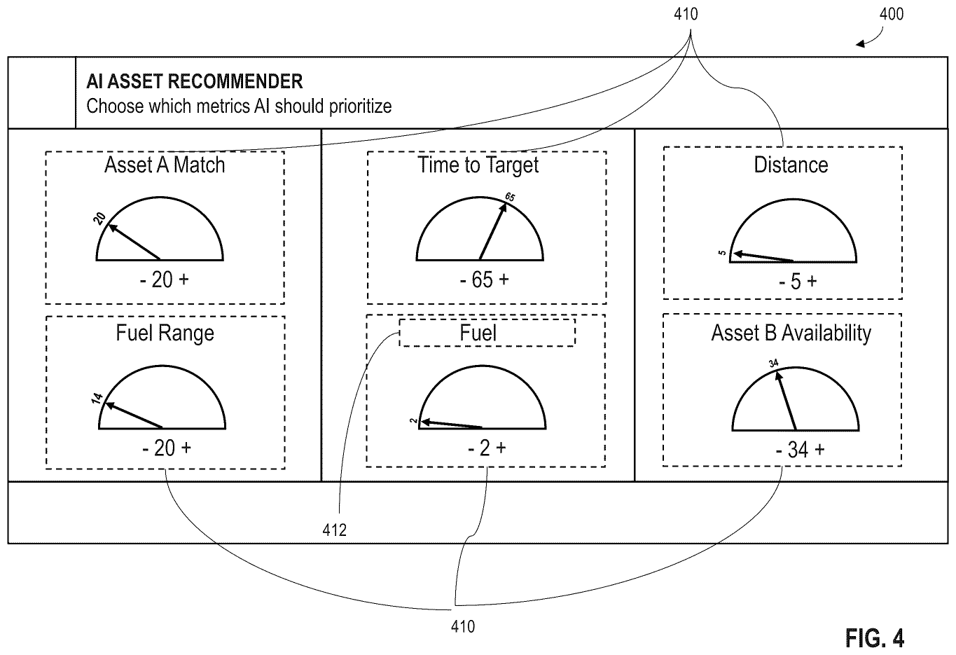

FIG. 4 illustrates an example user interface 400 for presenting one or more selected model parameters 412 and corresponding weights and values 410. In certain embodiments, the system selects a subset of model parameters from the parameters of the one or more pairing AI models, as the selected parameters to be presented via an interface (e.g., a user interface, a software interface, etc.). In some embodiments, the subset of model parameters (e.g., 16 parameters selected) is less than one-half of the parameters (e.g., 100 parameters) of the one or more pairing AI models. In certain embodiments, the subset of model parameters is less than one-fifth of the parameters of the one or more pairing AI models. In some embodiments, the subset of model parameters is less than one-tenth of the parameters of one or more pairing AI models.

According to certain embodiments, at process 120, the system receives an input associated with at least one of the one or more first values of the one or more weights, where the one or more weights are corresponding to one or more model parameters (e.g., selected model parameters) of the one or more pairing AI models. In some embodiments, the input can be via a user interface from a user or via a software interface (e.g., an application programming interface (API), a web service, etc.) from another system (e.g., another software module, another software application, etc.). As an example illustrated in FIG. 4, the input can be provided via the user interface.

According to some embodiments, at process 125, the system determines one or more second values of the one or more weights, where at least one of the one or more second values of the one or more weights is determined based at least in part on the input. In certain embodiments, a plurality of second values of the one or more weights are determined based at least in part on the input. In some examples, the weight values are set based on the user input. For example, as illustrated in FIG. 4, the weight value for “Time-to-Target” may be changed from 65 to 40.

According to certain embodiments, at process 130, the system modifies the one or more pairing AI models based on the one or more second values of the one or more weights. For example, one of the pairing AI models changes the weight value for a parameter (e.g., the “Time-to-Target” parameter) to the inputted second value. In some examples, the one or more modified pairing AI models are improved for recommending object-pairings.

In certain embodiments, the system receives data associated with a task. In some embodiments, the data associated with the task includes data associated with one or more asset objects, data associated with one or more target objects and/or target areas, and data associated with task contexts. For example, the data associated with one or more asset objects includes corresponding asset identifiers, the transportation object type (e.g., fire truck type, airplane type, etc.), the asset type (e.g., asset for fire controls, asset for rescue, etc.), availability, availability for specific time/date, geolocation, fuel, movement (e.g., speed, direction, heading), time-to-target, and/or the like. In certain embodiments, at least some of the data associated with one or more asset objects are dynamic, such that the data changes over time, such as before the task, during the task, and after the task. In some embodiments, the data associated with one or more target objects and/or target areas include corresponding target identifiers, the target type, geolocation, movement, object shape, and/or the like. In certain embodiments, the data associated with one or more task contexts include terrain (e.g., hills, flat plains, forests, trees, etc.), weather condition, wind (e.g., wind direction, wind speed, wind amplitude, etc.), rain, and/or the like.

In some embodiments, the system computes data for one or more combined parameters based on the data associated with the task. For example, the system computes the time-to-target for an asset using the location, speed, direction, and other data of the asset (e.g., a fuel airplane). In some examples, the system computes the asset-match data, for example, using an AI model. In certain examples, the system computes the fuel-range data for an asset. In certain embodiments, the one or more pairing AI models include a first AI model and a second AI model. In some examples, the system uses the first AI model to pre-process data associated with the task. In certain examples, the system generates object pairing by applying the second AI model to the processed data associated with the task.

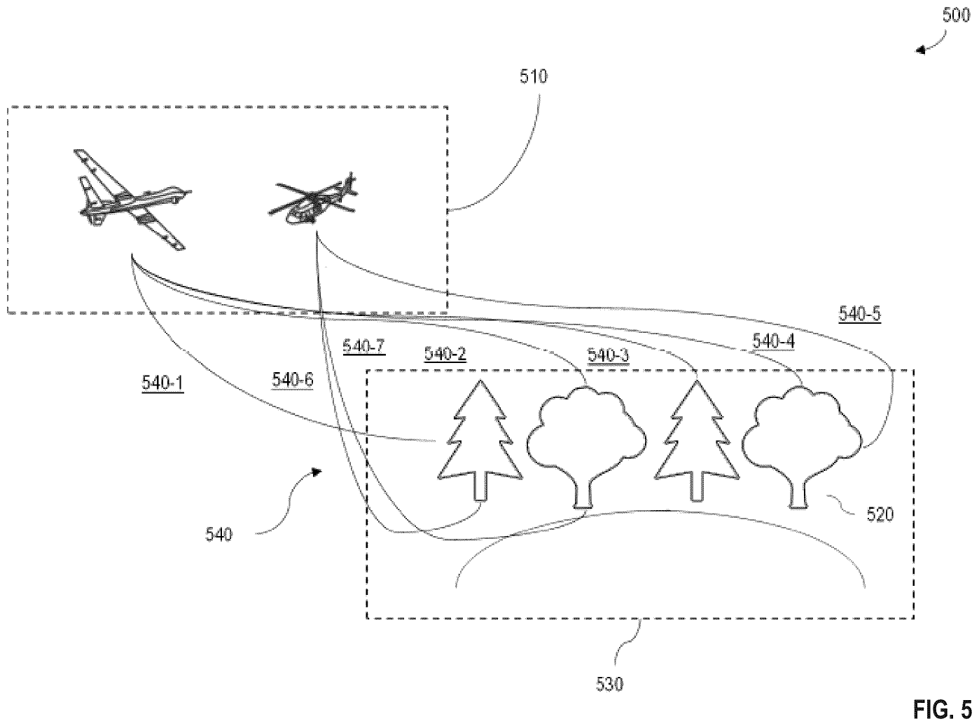

According to certain embodiments, at least one of the plurality of asset objects is a simulated asset object. In some embodiments, the system can generate simulated tasks (e.g., simulated missions) including simulated asset objects, simulated target objects, and/or simulated task contexts, and test pairing AI models using the simulated tasks. In certain embodiments, the system can present the simulated tasks including simulated asset objects, simulated target objects, and/or simulated task contexts (e.g., as shown in FIG. 5) and allows users or other systems to modify the one or more pairing AI models (e.g., as shown in FIG. 4). In some embodiments, the system can generate, store, use, and modify simulated objects and/or simulated tasks, such as simulated asset objects, simulated task contexts, simulated target objects, and/or the like.

According to some embodiments, at process 135, the system determines a plurality of object pairings for the task using the at least one modified pairing AI model applied to data associated with the task. In certain embodiments, each object pairing of the plurality of object pairings includes at least one asset object and at least one target object. In some embodiments, an object pairing includes an asset object and a target object.

According to certain embodiments, at process 140, the system generates a ranking associated with the plurality of object pairings for the task. In some embodiments, the ranking includes one or more ranking scores, where each object pairing of the plurality of object pairing corresponds to a ranking score. In certain embodiments, the ranking includes a linear score (e.g., 1 to 10, 1 to 100) in a score range for each object pairing of the plurality of object pairings. In some embodiments, the initial pairing AI model generates a first ranking, the modified pairing AI model generates a second ranking different from the first ranking. For example, Asset A-Target 1 pairing has a first ranking score in the first ranking and a second ranking score in the second ranking, where the second ranking score is higher (e.g., higher in ranking to be selected) than the first ranking score. In certain embodiments, at process 145, the system presents the plurality of object pairings for the task and the ranking. FIG. 5 is an illustrative user interface 500 including one or more asset objects 510, one or more target objects, one or more task contexts 530, and one or more object pairings 540. As illustrated, in some embodiments, the system generates multiple object pairings. In certain embodiments, the asset objects and the target objects can have multiple-to-multiple pairing relationships. In some embodiments, the user interface includes a three-dimensional (3D) presentation of the task contexts that allow users to select object pairings (e.g., task options), or reason about task options in space.

According to certain embodiments, the system selects an object pairing from the plurality of object pairings based at least in part on the ranking. In some embodiments, the system receives a plurality of tasks, generates a plurality of object pairings for each task, and determines a selected object pairing from the plurality of object pairings for each task of the plurality of tasks. In certain embodiments, the system builds a playbook including one or more selected object pairings. In some embodiments, the plan includes times and/or schedules for each selected object pairing. In certain embodiments, the plan includes one asset object in a plurality of selected object pairings corresponding to a plurality of tasks. In certain embodiments, the plan includes one asset object used at different times in a plurality of selected object pairings corresponding to a plurality of tasks. In some embodiments, the system generates, stores, and/or uses a task template for a type of target. In certain embodiments, a task template for a type of target includes one or more asset objects, one or more task contexts, and/or the like.

According to some embodiments, at process 150, the system receives an indication of a selected object pairing from the plurality of object pairings. For example, a user may select the object pairing from plurality of object pairings via an example user interface illustrated in FIG. 5. In certain examples, the indication of the selected object pairing is received via a user interface or a software interface. In some embodiments, at process 155, the system uses data associated with the selected object pairing and the ranking as training data for the one or more pairing AI models. In certain embodiments, the system retrains (e.g., trains recursively) the one or more pairing AI models using the training data, including the plurality of object pairings, the selected object pairing, and the ranking. In some embodiments, the system can improve the pairing AI models for recommend object pairings. In certain embodiments, the system uses data associated with the selected object pairing as positive training data for the one or more pairing AI models.

In some embodiments, the system uses data associated with at least one of the plurality of object pairings that is not the selected object pairing as negative training data for the one or more pairing AI models. In certain examples, only a part of the one or more unselected object pairings are used as training data. In some examples, the part of one or more unselected object pairings used as training data have top N ranking scores, where N is a positive predetermined integer.

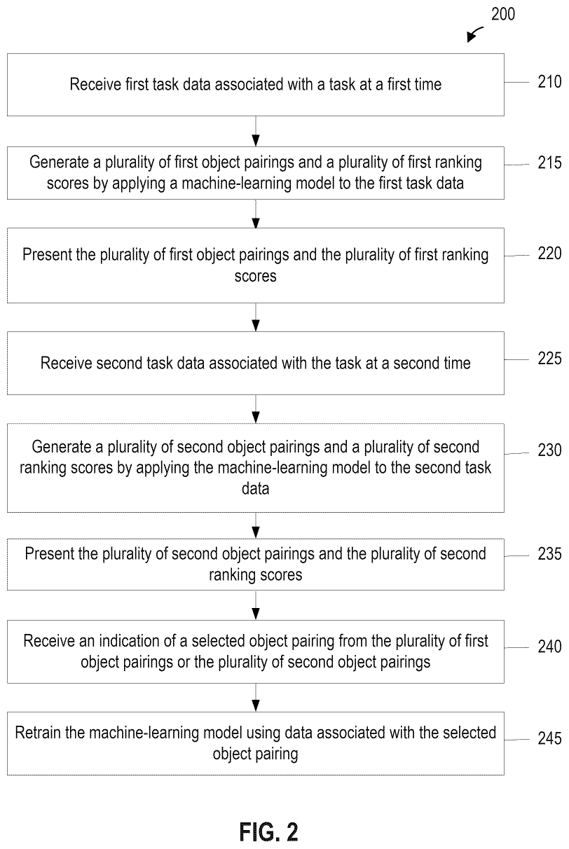

FIG. 2 is a simplified diagram showing a method 200 for object pairings using AI models according to certain embodiments of the present disclosure. This diagram is merely an example. One of ordinary skill in the art would recognize many variations, alternatives, and modifications. The method 200 for object pairings using AI models includes processes 210, 215, 220, 225, 230, 235, 240, and 245. Although the above has been shown using a selected group of processes for the method 200 for object pairings using AI models, there can be many alternatives, modifications, and variations. For example, some of the processes may be expanded and/or combined. Other processes may be inserted to those noted above. Depending upon the embodiment, the sequence of processes may be changed, and one or more processes may be replaced. Further details of these processes are found throughout the present disclosure.

In some embodiments, some or all processes (e.g., steps) of the method 200 are performed by a system (e.g., the computing system 600). In certain examples, some or all processes (e.g., steps) of the method 200 are performed by a computer and/or a processor directed by a code. For example, a computer includes a server computer and/or a client computer (e.g., a personal computer). In some examples, some or all processes (e.g., steps) of the method 100 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to certain embodiments, at process 210, the system receives first task data associated with a task at a first time. In some embodiments, the first task data include data associated with one or more asset objects, data associated with one or more target objects, and/or data associated with the task and task contexts. In some examples, at least a part of data associated with the task is static data. In certain embodiments, at least a part of the task data includes live data associated with at least one of the one or more asset object. In some embodiments, live data refers to data changing over time and provided to the system in real-time or near real-time (e.g., no more than 1 second, no more than 0.2 second, no more than 0.1 second, no more than 3 seconds, etc.).

For example, the data associated with one or more asset objects includes corresponding asset identifiers, the transportation object type (e.g., fire truck type, airplane type, etc.), the asset type (e.g., asset for fire controls, asset for rescue, etc.), availability, availability for specific time/date, geolocation, fuel, movement (e.g., speed, direction, heading), time-to-target, and/or the like. In certain embodiments, at least some of the data associated with one or more asset objects is dynamic, such that the data changes over time, such as before the task, during the task, and after the task. In some embodiments, the data associated with one or more target objects and/or target areas includes corresponding target identifiers, the target type, geolocation, movement, object shape, and/or the like. In certain embodiments, the data associated with one or more task contexts includes terrain (e.g., hills, flat plains, forests, trees, etc.), weather condition, wind (e.g., wind direction, wind speed, wind amplitude, etc.), rain, and/or the like.

In some embodiments, the system computes data for one or more combined parameters based on the data associated with the task. For example, the system computes the time-to-target for an asset using the location, speed, direction, and other data of the asset (e.g., a fuel airplane). In some examples, the system computes the asset-match data, for example, using an AI model. In certain examples, the system computes the fuel-range data for an asset. In certain embodiments, the one or more pairing AI models include a first AI model and a second AI model. In some examples, the system uses the first AI model to pre-process data associated with the task. In certain examples, the system generates object pairing by applying the second AI model to the processed data associated with the task.

According to certain embodiments, at least one of the plurality of asset objects is a simulated asset object. In some embodiments, the system can generate simulated tasks (e.g., simulated missions) including simulated asset objects, simulated target objects, and/or simulated task contexts, and test pairing AI models using the simulated tasks. In certain embodiments, the system can present the simulated tasks including simulated asset objects, simulated target objects, and/or simulated task contexts (e.g., as shown in FIG. 5) and allows users or other systems to modify the one or more pairing AI models (e.g., as shown in FIG. 4). In some embodiments, the system can generate, store, use, and modify simulated objects and/or simulated tasks, such as simulated asset objects, simulated task contexts, simulated target objects, and/or the like.

According to some embodiments, at process 215, the system generates a plurality of first object pairings and a plurality of first ranking scores by applying a machine-learning model to the first task data. In certain embodiments, the system generates the plurality of first object pairings and the plurality of first ranking scores by applying one or more paring AI models to the first task data. In some embodiments, the one or more pairing AI models include one or more model parameters associated with a task, the task including one or more asset objects, a target object, and/or one or more task contexts. In some embodiments, the one or more pairing AI models include a plurality of pairing AI models running in parallel and/or in sequence. In certain embodiments, the one or more pairing AI models include a first AI model and a second AI model, where output generated from the first pairing AI model is input to the second pairing AI model. In some embodiments, the one or more pairing AI models include a recommender model. In certain embodiments, the one or more pairing AI models include an artificial neural network (ANN) model and the one or more model parameters are for an input layer of the ANN model. In some embodiments, the ANN model is designed with a relatively small set of parameters such that the ANN model can generate output in real-time (e.g., less than 1 second, less than 0.2 second, less than 0.1 second, less than 3 seconds, etc.). In certain examples, the ANN model has an input layer having no more than 100 parameters. In some examples, the ANN model has an input layer having no more than 50 parameters.

In certain embodiments, each object pairing of the plurality of object pairings includes one or more asset objects and one or more target objects. In some embodiments, an object pairing includes an asset object and a target object. In some embodiments, each object pairing of the plurality of object pairing corresponds to a ranking score. In certain embodiments, the ranking includes a linear score (e.g., 1 to 10, 1 to 100) in a score range for each object pairing of the plurality of object pairings.

According to certain embodiments, at process 220, the system presents, on a display, the plurality of first object pairings and the plurality of first ranking scores. FIG. 5 is an illustrative user interface 500 including one or more asset objects 510, one or more target objects, one or more task contexts 530, and one or more object pairings 540. As illustrated, in some embodiments, the system generates multiple object pairings. In certain embodiments, the asset objects and the target objects can have multiple-to-multiple pairing relationships. In some embodiments, the user interface includes a three-dimensional (3D) visualization of the task contexts that allow users to select object pairings (e.g., task options), or reason about object pairings in space.

In some embodiments, at process 225, the system receives second task data associated with the task at a second time. In certain embodiments, the second time is different from the first time. In some embodiments, the second time is later than the first time. In certain embodiments, the live data at the second time is different from the live data at the first time.

According to some embodiments, at process 230, the system generates a plurality of second object pairings and a plurality of second ranking scores by applying the machine-learning model to the second task data. In certain embodiments, at least one of the plurality of second object pairings is different from at least one of the plurality of first object pairings. In some embodiments, at least one of the plurality of second ranking scores is different from at least one of the plurality of first ranking scores for a same object pairing. As an example, the system generates an Asset A-Target 10 pairing in the plurality of second object pairings, where an Asset A-Target 10 pairing is not in the plurality of first object pairings. For example, Asset A-Target 1 pairing has a first ranking score generated using the first task data and Asset A-Target 1 pairing has a second ranking score generated using the second task data, where the first ranking score (e.g., 1 out of 5) is different from the second ranking score (e.g., 3 out of 5).

According to certain embodiments, at process 235, the system presents, on the display, the plurality of second object pairings and the plurality of second ranking scores. In some embodiments, at process 240, the system receives an indication of a selected object pairing from the plurality of first object pairings or the plurality of second object pairings. In some embodiments, the process 240 may occur after the process 220 and/or after the process 235.

According to some embodiments, at process 245, the system retrains the one or more AI models (e.g., the machine-learning model) using data associated with the selected object pairing. In certain embodiments, the system uses data associated with the selected object pairing and the ranking including the corresponding ranking score as training data for the one or more pairing AI models. In certain embodiments, the system retrains (e.g., trains recursively) the one or more pairing AI models using the training data, including the plurality of object pairings, the selected object pairing, and the plurality of ranking scores. In some embodiments, the system can improve the pairing AI models for recommend object pairings. In certain embodiments, the system uses data associated with the selected object pairing as positive training data for the one or more pairing AI models.

In some embodiments, the system uses data associated with at least one of the plurality of object pairings that is not the selected object pairing as negative training data and/or corresponding ranking scores for the one or more pairing AI models. In certain examples, only a part of the one or more unselected object pairings are used as training data. In some examples, the part of one or more unselected object pairings used as training data have top N ranking scores, where N is a positive predetermined integer.

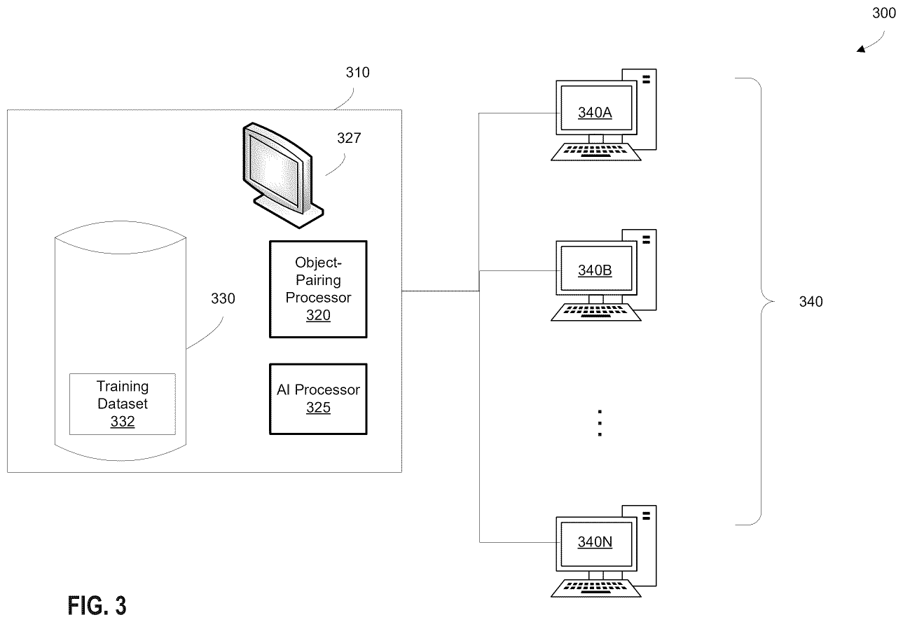

FIG. 3 is an illustrative tasking (e.g., object pairings) operating environment 300 according to certain embodiments of the present disclosure. In some embodiments, the tasking operating environment 300 includes one or more object-pairing systems (e.g., object-pairing software modules) 310 and one or more computing devices 340 (e.g., computing device 340A, computing device 340B, . . . computing device 340N, etc.). In certain embodiments, the object-pairing system 310 includes one or more object-pairing processors 320, one or more AI processors 325, one or more displays 327, and one or more data repositories 330. In some embodiments, the one or more data repositories 330 include one or more training datasets, for example, for one or more pairing AI models and/or one or more parameter models. In certain embodiments, the computing device 340 may include and/or access at least a part of the functionality of the object-pairing system 310. Although the above has been shown using a selected group of components in the tasking operating environment 300, there can be many alternatives, modifications, and variations. For example, some of the components may be expanded and/or combined. Other components may be inserted into those noted above. Depending upon the embodiment, the arrangement of components may be interchanged with others replaced. Further details of these components are found throughout the present disclosure.

According to certain embodiments, the object-pairing system 310 (e.g., the object-pairing processor 320, the AI processor 325, etc.) generates, updates, and/or uses one or more pairing AI models. In some embodiments, the one or more pairing AI models include a plurality of pairing AI models running in parallel and/or in sequence. In certain embodiments, the one or more pairing AI model include a first AI model and a second AI model, where output generated from the first pairing AI model is input to the second pairing AI model. In certain embodiments, the one or more pairing AI models include an artificial neural network (ANN) model and the one or more model parameters are for an input layer of the ANN model. In some embodiments, the ANN model is designed with a relatively small set of parameters such that the ANN model can generate output in real-time (e.g., less than 1 second, less than 0.2 second, less than 0.1 second, less than 3 seconds, etc.). In certain examples, the ANN model has an input layer having no more than 100 parameters. In some examples, the ANN model has an input layer having no more than 50 parameters. In certain embodiments, the one or more pairing AI models include one or more recommender models.

According to some embodiments, the object-pairing system 310 (e.g., the object-pairing processor 320, the AI processor 325, etc.) selects one or more model parameters associated with one or more pairing AI models using a parameter AI model. In some embodiments, the parameter AI model includes a generative AI model to generate and/or select the one or more model parameters. In certain embodiments, the parameter AI model includes a generative AI model configured to generate the one or more pairing AI model. In some embodiments, the parameter AI model (e.g., a language model, an LLM, etc.) can be trained using corpus including historical tasks, historical object pairings, historical model parameters, and/or other data and the parameter AI model is designed to generate model parameters for the one or more pairing AI models. In certain embodiments, the parameter AI model (e.g., a language model, an LLM, etc.) can be trained using training dataset 332 including historical tasks, historical object pairings, historical models, and/or other data and the parameter AI model is designed to generate the one or more pairing AI models.

In some embodiments, the model parameters are associated with one or more tasks and/or one or more types of tasks. In certain embodiments, the task includes one or more asset objects, one or more target objects, one or more task contexts, and/or the like. In some embodiments, the model parameters include one or more task parameters, one or more target object parameters, one or more asset object parameters, one or more task context parameters, and/or the like. In certain embodiments, the task parameters include a time, a sequence of times, geolocation, distance, and/or the like. For example, one or more task context parameters include one or more parameters associated with the task environment, such as weather, wind, terrain, and/or the like.

In some embodiments, the one or more object parameters include an object type, a location parameter, a geospatial parameter, a temporal parameter, a speed parameter, an orientation parameter, a movement parameter, a shape parameter, a spectrum parameter, an object image parameter, a fuel parameter, and/or the like. In certain embodiments, the one or more asset object parameters include one or more object parameters, an asset match parameter, an asset availability parameter, and/or the like. In some embodiments, the one or more target object parameters include one or more object parameters, one or more target object characteristics, and/or the like. In some embodiments, the one or more model parameters include one or more combined parameters, such as a time-to-target, a fuel-range, and/or the like. In certain embodiments, a combined parameter includes a parameter corresponding to data that needs to be computed. For example, the time-to-target is computed using geolocation, distance, heading, and speed. As an example, the asset-match is computed using task information and asset information.

According to some embodiments, the object-pairing system 310 (e.g., the object-pairing processor 320, the AI processor 325, etc.) presents one or more model parameters and/or one or more first values of one or more weights in one or more pairing AI models, where the one or more weights correspond to one or more model parameters of the one or more pairing AI models, for example, associated with a task. In some embodiments, the one or more model parameters presented are selected from the parameters of the one or more pairing AI models. In certain embodiments, the one or more model parameters are selected based on a task and/or a task type. In some embodiments, a task type refers to a type of task that is associated with a set of target object types and a set of asset object types. For example, a disaster relief task type is associated with target object types of buildings, areas, and/or the like, and asset object types of fire engines, firefighters, rescue persons, rescue robots, airplanes, UAVs, and/or the like.

FIG. 4 illustrates an example user interface 400, for example, shown on the display 327 and/or a computing device 340, for presenting one or more selected model parameters 412 and corresponding weights and values 410. In certain embodiments, the system selects a subset of model parameters from the parameters of the one or more pairing AI models, as the selected parameters to be presented via an interface (e.g., a user interface, a software interface, etc.). In some embodiments, the subset of model parameters (e.g., 16 parameters selected) is less than one-half of the parameters (e.g., 100 parameters) of the one or more pairing AI models. In certain embodiments, the subset of model parameters is less than one-fifth of the parameters of the one or more pairing AI models. In some embodiments, the subset of model parameters is less than one-tenth of the parameters of one or more pairing AI models.

According to certain embodiments, the object-pairing system 310 (e.g., the object-pairing processor 320, the AI processor 325, etc.) receives an input associated with at least one of the one or more first values of the one or more weights, where the one or more weights are corresponding to one or more model parameters (e.g., selected model parameters) of the one or more pairing AI models. In some embodiments, the input can be via a user interface, for example, shown on the display 327 and/or a computing device 340, from a user or via a software interface (e.g., an application programming interface (API), a web service, etc.) from another system (e.g., another software module, another software application, etc.). As an example illustrated in FIG. 4, the input can be provided via the user interface.

According to some embodiments, the object-pairing system 310 (e.g., the object-pairing processor 320, the AI processor 325, etc.) determines one or more second values of the one or more weights, where at least one of the one or more second values of the one or more weights is determined based at least in part on the input. In certain embodiments, a plurality of second values of the one or more weights are determined based at least in part on the input. In some examples, the weight values are set based on the user input received via the user interface, for example, shown on the display 327 and/or a computing device 340. For example, as illustrated in FIG. 4, the weight value for “Time-to-Target” may be changed from 65 to 40.

According to certain embodiments, the object-pairing system 310 (e.g., the object-pairing processor 320, the AI processor 325, etc.) modifies the one or more pairing AI models based on the one or more second values of the one or more weights. For example, one of the pairing AI models changes the weight value for a parameter (e.g., the “Time-to-Target” parameter) to the inputted second value. In some examples, the one or more modified pairing AI models are improved for recommending object-pairings.

In certain embodiments, the object-pairing system 310 (e.g., the object-pairing processor 320, the AI processor 325, etc.) receives data associated with a task. In some embodiments, the data associated with the task includes data associated with one or more asset objects, data associated with one or more target objects and/or target areas, and data associated with task contexts. For example, the data associated with one or more asset objects includes corresponding asset identifiers, the transportation object type (e.g., fire truck type, airplane type, etc.), the asset type (e.g., asset for fire controls, asset for rescue, etc.), availability, availability for specific time/date, geolocation, fuel, movement (e.g., speed, direction, heading), time-to-target, and/or the like. In certain embodiments, at least some of the data associated with one or more asset objects is dynamic, such that the data changes over time, such as before the task, during the task, and after the task. In some embodiments, the data associated with one or more target objects and/or target areas includes corresponding target identifiers, the target type, geolocation, movement, object shape, and/or the like. In certain embodiments, the data associated with one or more task contexts includes terrain (e.g., hills, flat plains, forests, trees, etc.), weather condition, wind (e.g., wind direction, wind speed, wind amplitude, etc.), rain, and/or the like.

In some embodiments, the object-pairing system 310 (e.g., the object-pairing processor 320, the AI processor 325, etc.) computes data for one or more combined parameters based on the data associated with the task. For example, the object-pairing system 310 (e.g., the object-pairing processor 320, the AI processor 325, etc.) computes the time-to-target for an asset using the location, speed, direction, and other data of the asset (e.g., a fuel airplane). In some examples, the object-pairing system 310 (e.g., the object-pairing processor 320, the AI processor 325, etc.) computes the asset-match data, for example, using an AI model. In certain examples, the object-pairing system 310 (e.g., the object-pairing processor 320, the AI processor 325, etc.) computes the fuel-range data for an asset. In certain embodiments, the one or more pairing AI models include a first AI model and a second AI model. In some examples, the object-pairing system 310 (e.g., the object-pairing processor 320, the AI processor 325, etc.) uses the first AI model to pre-process data associated with the task. In certain examples, the object-pairing system 310 (e.g., the object-pairing processor 320, the AI processor 325, etc.) generates object pairing by applying the second AI model to the processed data associated with the task.

According to certain embodiments, at least one of the plurality of asset objects is a simulated asset object. In some embodiments, the object-pairing system 310 (e.g., the object-pairing processor 320, the AI processor 325, etc.) can generate simulated tasks (e.g., simulated missions) including simulated asset objects, simulated target objects, and/or simulated task contexts, and test pairing AI models using the simulated tasks. In certain embodiments, the object-pairing system 310 (e.g., the object-pairing processor 320, the AI processor 325, etc.) can present the simulated tasks including simulated asset objects, simulated target objects, and/or simulated task contexts (e.g., as shown in FIG. 5) and allows users or other systems to modify the one or more pairing AI models (e.g., as shown in FIG. 4). In some embodiments, the object-pairing system 310 (e.g., the object-pairing processor 320, the AI processor 325, etc.) can generate, store, use, and modify simulated objects and/or simulated tasks, such as simulated asset objects, simulated task contexts, simulated target objects, and/or the like.

According to some embodiments, the object-pairing system 310 (e.g., the object-pairing processor 320, the AI processor 325, etc.) determines a plurality of object pairings for the task using the at least one modified pairing AI model applied to data associated with the task. In certain embodiments, each object pairing of the plurality of object pairings includes at least one asset object and at least one target object. In some embodiments, an object pairing includes an asset object and a target object.

According to certain embodiments, the object-pairing system 310 (e.g., the object-pairing processor 320, the AI processor 325, etc.) generates a ranking associated with the plurality of object pairings for the task. In some embodiments, the ranking includes one or more ranking scores, where each object pairing of the plurality of object pairing corresponds to a ranking score. In certain embodiments, the ranking includes a linear score (e.g., 1 to 10, 1 to 100) in a score range for each object pairing of the plurality of object pairings. In some embodiments, the initial pairing AI model generates a first ranking, the modified pairing AI model generates a second ranking different from the first ranking. For example, Asset A-Target 1 pairing has a first ranking score in the first ranking and a second ranking score in the second ranking, where the second ranking score is higher (e.g., higher in ranking to be selected) than the first ranking score. In certain embodiments, at process 145, the object-pairing system 310 (e.g., the object-pairing processor 320, the AI processor 325, etc.) presents the plurality of object pairings for the task and the ranking. FIG. 5 is an illustrative user interface 500 including one or more asset objects 510, one or more target objects, one or more task contexts 530, and one or more object pairings 540. As illustrated, in some embodiments, the object-pairing system 310 (e.g., the object-pairing processor 320, the AI processor 325, etc.) generates multiple object pairings. In certain embodiments, the asset objects and the target objects can have multiple-to-multiple pairing relationships. In some embodiments, the user interface rendered on the display 327 and/or a computing device 340 includes a three-dimensional (3D) presentation of the task contexts that allow users to select object pairings (e.g., task options), or reason about task options in space.

According to certain embodiments, the object-pairing system 310 (e.g., the object-pairing processor 320, the AI processor 325, etc.) selects an object pairing from the plurality of object pairings based at least in part on the ranking. In some embodiments, the object-pairing system 310 (e.g., the object-pairing processor 320, the AI processor 325, etc.) receives a plurality of tasks, generates a plurality of object pairings for each task, and determines a selected object pairing from the plurality of object pairings for each task of the plurality of tasks. In certain embodiments, the object-pairing system 310 (e.g., the object-pairing processor 320, the AI processor 325, etc.) builds a playbook including one or more selected object pairings. In some embodiments, the plan includes times and/or schedules for each selected object pairing. In certain embodiments, the plan includes one asset object in a plurality of selected object pairings corresponding to a plurality of tasks. In certain embodiments, the plan includes one asset object used at different times in a plurality of selected object pairings corresponding to a plurality of tasks. In some embodiments, the object-pairing system 310 (e.g., the object-pairing processor 320, the AI processor 325, etc.) generates, stores, and/or uses a task template for a type of target. In certain embodiments, a task template for a type of target includes one or more asset objects, one or more task contexts, and/or the like.

According to some embodiments, the object-pairing system 310 (e.g., the object-pairing processor 320, the AI processor 325, etc.) receives an indication of a selected object pairing from the plurality of object pairings. For example, a user may select the object pairing from plurality of object pairings via an example user interface rendered on the display 327 and/or on the computing device 340. In certain examples, the indication of the selected object pairing is received via a user interface or a software interface. In some embodiments, the object-pairing system 310 (e.g., the object-pairing processor 320, the AI processor 325, etc.) receives second task data associated with the task at a second time, where the task data is a first task data received (e.g., obtained) at a first time. In certain embodiments, the second time is different from the first time. In some embodiments, the second time is later than the first time. In certain embodiments, the live data at the second time is different from the live data at the first time.

According to some embodiments, the object-pairing system 310 (e.g., the object-pairing processor 320, the AI processor 325, etc.) generates a plurality of second object pairings and a plurality of second ranking scores by applying the one or more pairing AI models (e.g., the modified machine-learning model) to the second task data. In certain embodiments, at least one of the plurality of second object pairings is different from at least one of the plurality of first object pairings. In some embodiments, at least one of the plurality of second ranking scores is different from at least one of the plurality of first ranking scores for a same object pairing. As an example, the object-pairing system 310 (e.g., the object-pairing processor 320, the AI processor 325, etc.) generates an Asset A-Target 10 pairing in the plurality of second object pairings, where an Asset A-Target 10 pairing is not in the plurality of first object pairings. For example, Asset A-Target 1 pairing has a first ranking score generated using the first task data and Asset A-Target 1 pairing has a second ranking score generated using the second task data, where the first ranking score (e.g., 1 out of 5) is different from the second ranking score (e.g., 3 out of 5).

According to certain embodiments, the object-pairing system 310 (e.g., the object-pairing processor 320, the AI processor 325, etc.) presents, on the display 327 and/or on the computing device 340, the plurality of second object pairings and the plurality of second ranking scores. In some embodiments, the object-pairing system 310 (e.g., the object-pairing processor 320, the AI processor 325, etc.) receives an indication of a selected object pairing from the plurality of first object pairings or the plurality of second object pairings.

In some embodiments, the object-pairing system 310 (e.g., the object-pairing processor 320, the AI processor 325, etc.) uses data associated with the selected object pairing and the ranking as training data for the one or more pairing AI models. In certain embodiments, the object-pairing system 310 (e.g., the object-pairing processor 320, the AI processor 325, etc.) retrains (e.g., trains recursively) the one or more pairing AI models using the training data, including the plurality of object pairings, the selected object pairing, and the ranking. In some embodiments, the object-pairing system 310 (e.g., the object-pairing processor 320, the AI processor 325, etc.) can improve the pairing AI models for recommending object pairings. In certain embodiments, the object-pairing system 310 (e.g., the object-pairing processor 320, the AI processor 325, etc.) uses data associated with the selected object pairing as positive training data for the one or more pairing AI models.

In some embodiments, the object-pairing system 310 (e.g., the object-pairing processor 320, the AI processor 325, etc.) uses data associated with at least one of the plurality of object pairings that is not the selected object pairing as negative training data for the one or more pairing AI models. In certain examples, only a part of the one or more unselected object pairings are used as training data. In some examples, the part of one or more unselected object pairings used as training data have top N ranking scores, where N is a positive predetermined integer. In certain embodiments, retraining the one or more pairing AI models can improve the pairing AI models for recommending or determining object pairings.

In some embodiments, the one or more repositories 330 can include one or more training datasets, one or more pairing AI models, parameters and weight values for the one or more pairing AI models, one or more parameter models, data associated with one or more asset objects, data associated with one or more target objects, data associated with one or more tasks, data associated with one or more task contexts, data associated with one or more object pairings, data associated with selected object pairings, and/or the like. The repository may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some cases, various components in the tasking operating environment 300 can execute software or firmware stored in non-transitory computer-readable medium to implement various processing steps. Various components and processors of the tasking operating environment 300 can be implemented by one or more computing devices including, but not limited to, circuits, a computer, a cloud-based processing unit, a processor, a processing unit, a microprocessor, a mobile computing device, and/or a tablet computer. In some cases, various components of the tasking operating environment 300 (e.g., the one or more object-pairing systems 310, the one or more object-pairing processors 320, the one or more AI processors 325, the one or more computing devices 340) can be implemented on a shared computing device. Alternatively, a component of the operating environment 300 can be implemented on multiple computing devices. In some implementations, various modules and components of the operating environment 300 can be implemented as software, hardware, firmware, or a combination thereof. In some cases, various components of the tasking operating environment 300 can be implemented in software or firmware executed by a computing device.

Various components of tasking operating environment 300 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

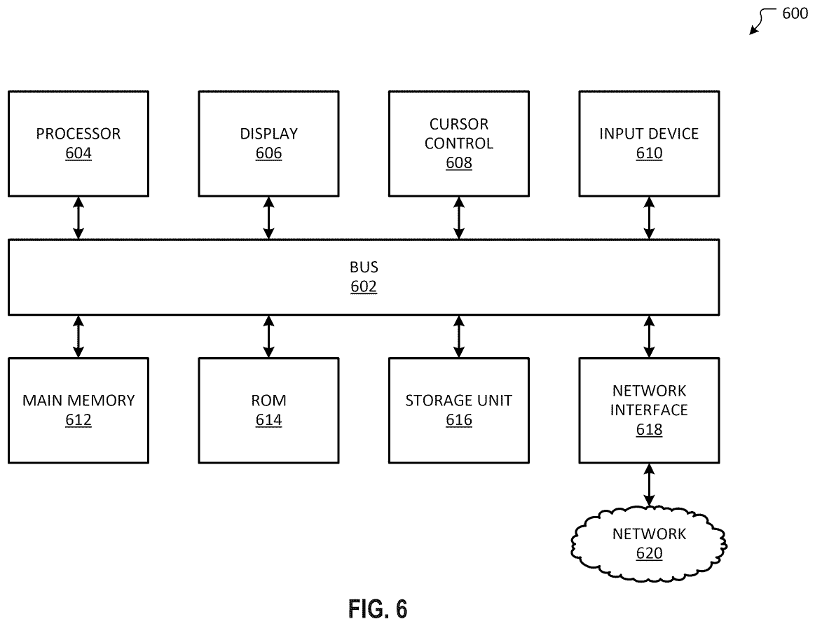

FIG. 6 is a simplified diagram showing a computing system for implementing a system 600 for object pairings in accordance with at least one example set forth in the disclosure. This diagram is merely an example, which should not unduly limit the scope of the claims. One of ordinary skill in the art would recognize many variations, alternatives, and modifications.

The computing system 600 includes a bus 602 or other communication mechanism for communicating information, a processor 604, a display 606, a cursor control component 608, an input device 610, a main memory 612, a read only memory (ROM) 614, a storage unit 616, and a network interface 618. In some embodiments, some or all processes (e.g., steps) of the methods 100 and/or 200 are performed by the computing system 600. In some examples, the bus 602 is coupled to the processor 604, the display 606, the cursor control component 608, the input device 610, the main memory 612, the read only memory (ROM) 614, the storage unit 616, and/or the network interface 618. In certain examples, the network interface is coupled to a network 620. For example, the processor 604 includes one or more general purpose microprocessors. In some examples, the main memory 612 (e.g., random access memory (RAM), cache and/or other dynamic storage devices) is configured to store information and instructions to be executed by the processor 604. In certain examples, the main memory 612 is configured to store temporary variables or other intermediate information during execution of instructions to be executed by processor 604. For example, the instructions, when stored in the storage unit 616 accessible to processor 604, render the computing system 600 into a special-purpose machine that is customized to perform the operations specified in the instructions. In some examples, the ROM 614 is configured to store static information and instructions for the processor 604. In certain examples, the storage unit 616 (e.g., a magnetic disk, optical disk, or flash drive) is configured to store information and instructions.

In some embodiments, the display 606 (e.g., a cathode ray tube (CRT), an LCD display, or a touch screen) is configured to display information to a user of the computing system 600. In some examples, the input device 610 (e.g., alphanumeric and other keys) is configured to communicate information and commands to the processor 604. For example, the cursor control component 608 (e.g., a mouse, a trackball, or cursor direction keys) is configured to communicate additional information and commands (e.g., to control cursor movements on the display 606) to the processor 604.

According to certain embodiments, a method for object pairings, the method comprising: presenting, on a display, one or more first values of one or more weights in a machine-learning model, the one or more weights corresponding to one or more model parameters associated with a task, the task including one or more asset objects, a target object, and one or more task contexts; receiving an input associated with at least one of the one or more first values of the one or more weights; determining one or more second values of the one or more weights, at least one second value of the one or more second values of the one or more weights being determined based at least in part on the input; modifying the machine-learning model based on the one or more second values of the one or more weights; determining a plurality of object pairings for the task using the modified machine-learning model applied to data associated with the task, each object pairing of the plurality of object pairings including an asset object and the target object; and generating a ranking associated with the plurality of object pairings for the task; wherein the method is performed by one or more processors. For example, the method is implemented according to at least FIG. 1, FIG. 2, and/or FIG. 3.

In some embodiments, the method further comprises: presenting the plurality of object pairings for the task and the ranking; and receiving an indication of a selected object pairing from the plurality of object pairings. In certain embodiments, the method further comprises: using data associated with the selected object pairing and the ranking as training data for the modified machine-learning model. In some embodiments, the method further comprises: using the data associated with the selected object pairing as positive training data for the modified machine-learning model. In certain embodiments, the method further comprises: using data associated with at least one of the plurality of object pairings that is not the selected object pairing as negative training data for the modified machine-learning model. In some embodiments, the method further comprises: retraining the modified machine-learning model using the positive training data and the negative training data. In certain embodiments, the one or more model parameters include at least one selected from a group consisting of one or more target object parameters, one or more asset object parameters, and one or more task context parameters.

In some embodiments, the machine-learning model includes an artificial neural network model, wherein at least one of the one or more model parameters is in an input layer of the artificial neural network model. In certain embodiments, the target object is a first target object of a plurality of target objects and the asset object is a first asset object of a plurality of asset objects, wherein the plurality of object pairings include one or more second pairings associated with a second target object of the plurality of target objects different from the first target object, and wherein the plurality of object pairings include multiple-to-multiple pairings between the plurality of asset objects and the plurality of target objects. In some embodiments, at least one of the plurality of asset objects is a simulated asset object. In certain embodiments, the machine-learning model includes a first machine-learning model chained with a second machine-learning model.

In some embodiments, the first machine-learning model is a generative artificial intelligence model and the second machine-learning model is an artificial neural network model. In certain embodiments, the one or more model parameters are a subset of parameters in a plurality of parameters associated with the task. In some embodiments, the method further comprises selecting the one or more model parameters using a generative artificial intelligence model. In certain embodiments, the task is a first task of a plurality of tasks, wherein the method further comprises: determining a selected object pairing from the plurality of object pairings for each task of the plurality of tasks; and building a plan including one or more selected object pairings.

According to certain embodiments, a system for systems integration, the system comprising: one or more memories comprising instructions stored thereon; and one or more processors configured to execute the instructions and perform operations comprising: receiving a first data asset in a first data format from a first data source; receiving a second data asset in a second data format from a second data source, the second data format being different from the first data format, the second data source being different from the first data source; performing a correlation process to merge the first data asset in the first data format and the second data asset in the second data format to generate a unified data asset in a common data format, the common data format being different from the first data format, the common data format being different from the second data format; and providing the unified data asset in the common data format to a plurality of software applications. For example, the system is implemented according to at least FIG. 1, FIG. 2, and/or FIG. 3.

In some embodiments, the method further comprises: receiving an input associated with at least one of one or more first values of the one or more weights corresponding to the one or more model parameters; determining one or more second values of the one or more weights, at least one second value of the one or more second values of the one or more weights being determined based at least in part on the input; and modifying the machine-learning model based on the one or more second values of the one or more weights. In certain embodiments, the method further comprises: determining a plurality of third object pairings and a plurality of third ranking scores by applying the modified machine-learning model to the second task data associated with the task. In some embodiments, the method further comprises: receiving an indication of a selected object pairing from the plurality of first object pairings or the plurality of second object pairings; retrain the machine-learning model using data associated with the selected object pairing.

According to some embodiments, a system for object pairings, the system comprising: one or more memories comprising instructions stored thereon; and one or more processors configured to execute the instructions and perform operations comprising: presenting, on a display, one or more first values of one or more weights in a machine-learning model, the one or more weights corresponding to one or more model parameters associated with a task, the task including one or more asset objects, a target object, and one or more task contexts; receiving an input associated with at least one of the one or more first values of the one or more weights; determining one or more second values of the one or more weights, at least one second value of the one or more second values of the one or more weights being determined based at least in part on the input; modifying the machine-learning model based on the one or more second values of the one or more weights; determining a plurality of object pairings for the task using the modified machine-learning model applied to data associated with the task, each object pairing of the plurality of object pairings including an asset object and the target object; and generating a ranking associated with the plurality of object pairings for the task. For example, the system is implemented according to at least FIG. 1, FIG. 2, and/or FIG. 3.

In some embodiments, the operations further comprise: presenting the plurality of object pairings for the task and the ranking; and receiving an indication of a selected object pairing from the plurality of object pairings. In certain embodiments, the operations further comprise: using data associated with the selected object pairing and the ranking as training data for the modified machine-learning model. In some embodiments, the operations further comprise: using the data associated with the selected object pairing as positive training data for the modified machine-learning model. In certain embodiments, the operations further comprise: using data associated with at least one of the plurality of object pairings that is not the selected object pairing as negative training data for the modified machine-learning model. In some embodiments, the operations further comprise: retraining the modified machine-learning model using the positive training data and the negative training data. In certain embodiments, the one or more model parameters include at least one selected from a group consisting of one or more target object parameters, one or more asset object parameters, and one or more task context parameters.

In some embodiments, the machine-learning model includes an artificial neural network model, wherein at least one of the one or more model parameters is in an input layer of the artificial neural network model. In certain embodiments, the target object is a first target object of a plurality of target objects and the asset object is a first asset object of a plurality of asset objects, wherein the plurality of object pairings include one or more second pairings associated with a second target object of the plurality of target objects different from the first target object, and wherein the plurality of object pairings include multiple-to-multiple pairings between the plurality of asset objects and the plurality of target objects. In some embodiments, at least one of the plurality of asset objects is a simulated asset object. In certain embodiments, the machine-learning model includes a first machine-learning model chained with a second machine-learning model.

In some embodiments, the first machine-learning model is a generative artificial intelligence model and the second machine-learning model is an artificial neural network model. In certain embodiments, the one or more model parameters are a subset of parameters in a plurality of parameters associated with the task. In some embodiments, the operations further comprise selecting the one or more model parameters using a generative artificial intelligence model. In certain embodiments, the task is a first task of a plurality of tasks, wherein the operations further comprise: determining a selected object pairing from the plurality of object pairings for each task of the plurality of tasks; and building a plan including one or more selected object pairings.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for object pairings, the method comprising:
presenting, on a display, one or more first values of one or more weights in a machine-learning model, the one or more weights corresponding to one or more model parameters associated with a task, the task including one or more asset objects, a target object, and one or more task contexts;
receiving an input associated with at least one of the one or more first values of the one or more weights;
determining one or more second values of the one or more weights, at least one second value of the one or more second values of the one or more weights being determined based at least in part on the input;
modifying the machine-learning model based on the one or more second values of the one or more weights;
determining a plurality of object pairings for the task by applying the modified machine-learning model to data associated with the task, each object pairing of the plurality of object pairings including an asset object and the target object; and
generating a ranking associated with the plurality of object pairings for the task;
wherein the method is performed by one or more processors.

2. The method of claim 1, further comprising:
presenting the plurality of object pairings for the task and the ranking; and
receiving an indication of a selected object pairing from the plurality of object pairings.

3. The method of claim 2, further comprising:
using data associated with the selected object pairing and the ranking as training data for the modified machine-learning model.

4. The method of claim 3, further comprising:
using the data associated with the selected object pairing as positive training data for the modified machine-learning model.

5. The method of claim 4, further comprising:
using data associated with at least one of the plurality of object pairings that is not the selected object pairing as negative training data for the modified machine-learning model.

6. The method of claim 5, further comprising:
retraining the modified machine-learning model using the positive training data and the negative training data.

7. The method of claim 1, wherein the one or more model parameters include at least one selected from a group consisting of one or more target object parameters, one or more asset object parameters, and one or more task context parameters.

8. The method of claim 1, wherein the machine-learning model includes an artificial neural network model, wherein at least one of the one or more model parameters is in an input layer of the artificial neural network model.

9. The method of claim 1, wherein the target object is a first target object of a plurality of target objects and the asset object is a first asset object of a plurality of asset objects, wherein the plurality of object pairings include one or more second pairings associated with a second target object of the plurality of target objects different from the first target object, and wherein the plurality of object pairings include multiple-to-multiple pairings between the plurality of asset objects and the plurality of target objects.

10. The method of claim 9, wherein at least one of the plurality of asset objects is a simulated asset object.

11. The method of claim 1, wherein the machine-learning model includes a first machine-learning model chained with a second machine-learning model.

12. The method of claim 11, wherein the first machine-learning model is a generative artificial intelligence model and the second machine-learning model is an artificial neural network model.

13. The method of claim 1, wherein the one or more model parameters are a subset of parameters in a plurality of parameters associated with the task.

14. The method of claim 1, further comprising:
selecting the one or more model parameters using a generative artificial intelligence model.

15. The method of claim 1, wherein the task is a first task of a plurality of tasks, wherein the method further comprises:
determining a selected object pairing from the plurality of object pairings for each task of the plurality of tasks; and
building a plan including one or more selected object pairings.

16. A method for object pairings, the method comprising:
receiving first task data associated with a task at a first time, the first task data including data associated with one or more asset objects, data associated with one or more target objects, and data associated with the task, at least a part of the first task data including live data associated with at least one of the one or more asset objects;
generating a plurality of first object pairings and a plurality of first ranking scores by applying a machine-learning model to the first task data, the machine-learning model including one or more model parameters associated with a task, the task including the one or more asset objects, a target object, and one or more task contexts;
presenting, on a display, the plurality of first object pairings and the plurality of first ranking scores;
receiving second task data associated with the task at a second time, the second time being later than the first time, the live data at the second time being different from the live data at the first time;
generating a plurality of second object pairings and a plurality of second ranking scores by applying the machine-learning model to the second task data, at least one of the plurality of second object pairings being different from at least one of the plurality of first object pairings or at least one of the plurality of second ranking scores being different from at least one of the plurality of first ranking scores for a same object pairing;
presenting, on the display, the plurality of second object pairings and the plurality of second ranking scores;
wherein the method is performed by one or more processors.

17. The method of claim 16, further comprising:
receiving an input associated with at least one of one or more first values of the one or more weights corresponding to the one or more model parameters;
determining one or more second values of the one or more weights, at least one second value of the one or more second values of the one or more weights being determined based at least in part on the input; and
modifying the machine-learning model based on the one or more second values of the one or more weights.

18. The method of claim 17, further comprising:
determining a plurality of third object pairings and a plurality of third ranking scores by applying the modified machine-learning model to the second task data associated with the task.

19. The method of claim 16, further comprising:
receiving an indication of a selected object pairing from the plurality of first object pairings or the plurality of second object pairings;
retrain the machine-learning model using data associated with the selected object pairing.

20. A system for object pairings, the system comprising:
one or more memories comprising instructions stored thereon; and
one or more processors configured to execute the instructions and perform operations comprising:
presenting, on a display, one or more first values of one or more weights in a machine-learning model, the one or more weights corresponding to one or more model parameters associated with a task, the task including one or more asset objects, a target object, and one or more task contexts;
receiving an input associated with at least one of the one or more first values of the one or more weights;
determining one or more second values of the one or more weights, at least one second value of the one or more second values of the one or more weights being determined based at least in part on the input;
modifying the machine-learning model based on the one or more second values of the one or more weights;
determining a plurality of object pairings for the task by applying the modified machine-learning model to data associated with the task, each object pairing of the plurality of object pairings including an asset object and the target object; and
generating a ranking associated with the plurality of object pairings for the task.
